(19) United States
(12) Patent Application Publication
(10) Pub. No.: US 2014/0151591 A1
(43) Pub. Date: Jun. 5, 2014

(54) Gas Tap for a Cooking Appliance

(71) Applicant: COPRECITEC, S.L., ARETXABALETA (ES)

(72) Inventors: Unai GERENABARRENA MEABEBASTERRETXEA, EIBAR (ES); Ruben MATEOS MARTIN, Marietta, GA (US); Arturo Omar CERON VARELA, JALISCO - ZAPOPAN (MX); José Luis OLIVA AGUAYO, JALISCO (MX); Juan Jorge BRUNNER DIESTEL, JALISCO - ZAPOPAN (MX)

(73) Assignee: COPRECITEC, S.L., ARETXABALETA (ES)

(21) Appl. No.: 14/094,275

(22) Filed: Dec. 2, 2013

(30) Foreign Application Priority Data
Dec. 3, 2012 (ES) U201231288
Dec. 21, 2012 (ES) U201231357

(51) Int. Cl. F24C 3/12; F16K 31/44

(52) U.S. Cl. CPC F24C 3/12; F16K 31/44
USPC 251/227; 126/42

(57) ABSTRACT

A gas tap for a cooking appliance that includes a tap body with an internal housing. A gas flow regulating member is located in the internal housing and coupled to a manually-operated rotary shaft. The rotary shaft is moveable between a first axial position where its rotation is prevented and a second axial position whereupon its rotation is permit for regulating the flow of gas through the gas tap through the gas flow regulating member. The gas tap includes a return spring that resists against a movement of the rotary shaft from the first axial position to the second axial position. The gas tap also includes a resistance element, other than the return spring, that also resists against a movement of the rotary shaft from the first axial position to the second axial position.

### CROSS-REFERENCE TO RELATED APPLICATIONS

This application relates to and claims the benefit and priority to Spanish Patent Application No. 201231288, filed Dec. 3, 2012, and to Spanish Patent Application No. 201231357, filed Dec. 21, 2012.

### TECHNICAL FIELD

The present invention is related to a gas tap of the type having a rotating regulating member and a rotary driving shaft used in a cooking appliance, and particularly with means that resist against the pressing movement of the rotary shaft.

### BACKGROUND

Gas taps with pressing and turning means that allow the movement of the gas flow regulating member are known. Safety rules for operating gas taps require that to open the gas flow passage, at least two maneuvers must be performed first, such as pressing the rotary shaft and subsequently turning it, driving the conical regulating member until opening the gas flow.

GB682095 A discloses a gas tap comprising a tap body with a conical internal housing suitable for receiving a conical rotational member for regulating gas flow, and a manually-operated rotary shaft integrally coupled to the conical regulating member, and provided with a transverse rotation blocking means. The transverse blocking means comprises a positioning washer integrally fitted to the rotary shaft, the fitting allowing axial sliding and not rotary sliding on the shaft, the washer projecting perpendicular to the shaft, and an elastic washer assembled on the rotary shaft which can turn about the shaft and slide axially along the shaft.

To open the gas flow, the rotary shaft is pressed and the transverse means is thus released, and the shaft is then turned until reaching a position of the conical regulating member in which gas passage is opened. To prevent safety problems according to rules for operational safety, the gas tap comprises resistance means resisting against the movements. With respect to the pressing movement of the rotary shaft, the gas tap comprises a return spring of the rotary shaft that resists against the pressing movement of the shaft, the return spring being assembled between a flange of the shaft and the lower portion of the elastic washer. The gas tap also comprises a cover covering the housing of the tap body, the cover guiding the rotation of the shaft with the cooperation of the transverse blocking means.

### SUMMARY OF THE DISCLOSURE

According to some implementations a gas tap for a cooking appliance is provided that comprises a tap body with a conical internal housing suitable for receiving a conical rotational member for regulating gas flow, a manually-operated rotary shaft coupled to the conical regulating member, and provided with a transverse means accompanying the rotary shaft in its rotation, a return spring of the rotary shaft, arranged between the conical regulating member and the rotary shaft, that resists against the pressing movement of the shaft, and a cover covering the housing of the tap body and guiding the rotation of the shaft in cooperation with the transverse means. The gas tap comprises a resistance means, other than the return spring of the rotary shaft, resisting against the pressing movement of the rotary shaft. A safety measure against accidental movements of the rotary shaft is added to the measures required by the safety rules with this resistance means. A spring is added to the gas tap, insofar as the return spring has a close-fitting design for both fitting the conical member in the conical internal housing of the tap body, and for causing the rotary shaft to return against the cover when no pressing movement is applied on the shaft. Resorting to a stronger return spring can cause the conical member to become jammed in the conical internal housing of the tap body and not be able to perform the gas flow regulation function. These accidental movements that can be caused by the user can include the user unintentionally resting against or turning the shaft of the taps, or in the case of children, movements caused while playing. By arranging the resistance means, the accidental pressing movements the rotary shaft are hindered.

These and other advantages and features will become evident in view of the drawings and the detailed description.

### BRIEF DESCRIPTION OF THE DRAWINGS

FIG. 1 shows a longitudinal section view of an implementation of a gas tap for a cooking appliance with the resistance means arranged inside the gas tap.

FIG. 2 shows an exploded perspective view of the gas tap of FIG. 1.

FIG. 3 shows a plan view of the cover of the gas tap of FIG. 1.

FIG. 4 shows a longitudinal section view of an implementation of a gas tap for a cooking appliance with the resistance means arranged outside the tap body.

FIG. 5 shows a perspective view of the protective element of the gas tap of FIG. 4.

FIG. 5a shows a front view of the protective element of the gas tap of FIG. 4.

FIG. 6 shows a longitudinal section view of an implementation of a gas tap with the resistance means arranged outside the tap body.

FIG. 7 shows a perspective view of the fixed body of the protective assembly of the gas tap of FIG. 6.

FIG. 8 shows a longitudinal section view of the fixed body of FIG. 7.

FIG. 9 shows a perspective view of the movable body of the protective assembly of the gas tap of FIG. 6.

FIG. 10 shows a longitudinal section view of the movable body of FIG. 9.

FIG. 11 shows a longitudinal section view of an implementation of the gas tap with the resistance means arranged outside the tap body.

FIG. 12 shows a top perspective view of the ignition switch assembly of the gas tap of FIG. 11.

FIG. 13 shows a plan view of the ignition switch assembly of FIG. 12 without the front cover.

FIG. 14 shows a perspective view of the cam assembly of the ignition switch assembly of FIG. 12.

FIG. 15 shows a front section view of the ignition switch assembly according to line XII-XII of FIG. 12.

FIG. 15a shows a perspective section view of the ignition switch assembly according to line XII-XII of FIG. 12.

FIG. 16 shows a front perspective view of the drive cover of the ignition switch assembly of FIG. 12.

FIG. 17 shows a rear perspective view of the drive cover of the ignition switch assembly of FIG. 12.

FIG. 18 shows a cross-section view of the gas tap according to the XV-XV of FIG. 11.

### DETAILED DESCRIPTION

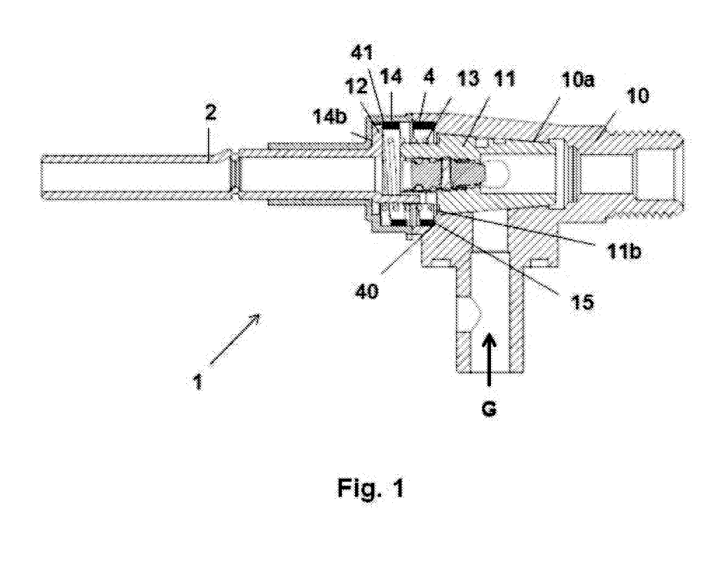

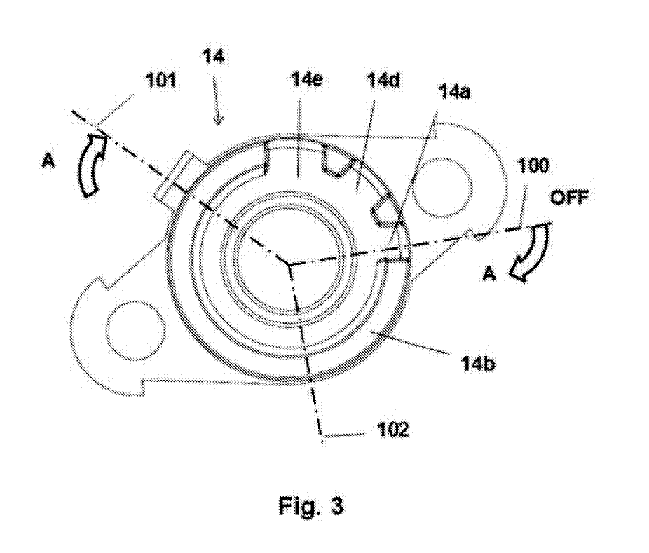

FIG. 1 shows a gas tap 1 for a cooking appliance according to one implementation comprising a tap body 10 with a conical internal housing 10a suitable for receiving a conical rotational member 11 for regulating gas flow G. The gas tap 1 also comprises a manually-operated rotary shaft 2 coupled to the conical regulating member 11, the rotary shaft 2 being provided with a transverse means 12, and a return spring 13 of the rotary shaft 2 that resists against the axial pressing movement of the rotary shaft 2 when the user operates the gas tap 1. The gas tap 1 also comprises a cover 14 for the housing 10a of the tap body 10 and for guiding the rotation of the rotary shaft 2 in cooperation with the transverse means 12. The rotary shaft 2 can rotate an angle A in either of the two directions for regulating a flow of a gas through the gas tap 1. The angle of rotation A is from an initial position 100 of rotation corresponding to the closed OFF position of the gas flow supply to a final position 101 corresponding to a minimum gas flow, passing through an intermediate position 102 of maximum gas flow supply, as shown in FIG. 3. According to one implementation the cover 14 is in the form of a tubular bushing, comprising a narrow tubular portion, the internal diameter of which fits the diameter of the shaft 2, and a cylindrical portion provided with a closure base resting on the tap body 10, and having a diameter that is greater or substantially greater than the diameter of the tubular portion. The cover 14 comprises on its internal face a sliding surface 14b which extends in the angle of rotation A, the transverse means 12 sliding on the sliding surface 14b when the rotary shaft 2 is being turned between at least the intermediate position 102 and the final position 101 of the angle of rotation A in both directions when the user no longer presses the rotary shaft 2, and he/she turns the shaft 2 in search for the suitable gas regulation position. The resistance against the pressing movement of the rotary shaft provided by the return spring 13 is slight, although it may comply with the regulatory requirement. As a result, the user may not perceive it as a deterrent force in the event of possible accidents. To make the pressing movement of the shaft 2 more difficult and to prevent accidents, the gas tap 1 comprises at least one resistance means 4. This resistance means 4, which is different from the return spring 13, resists against the axial movement of the rotary shaft 2.

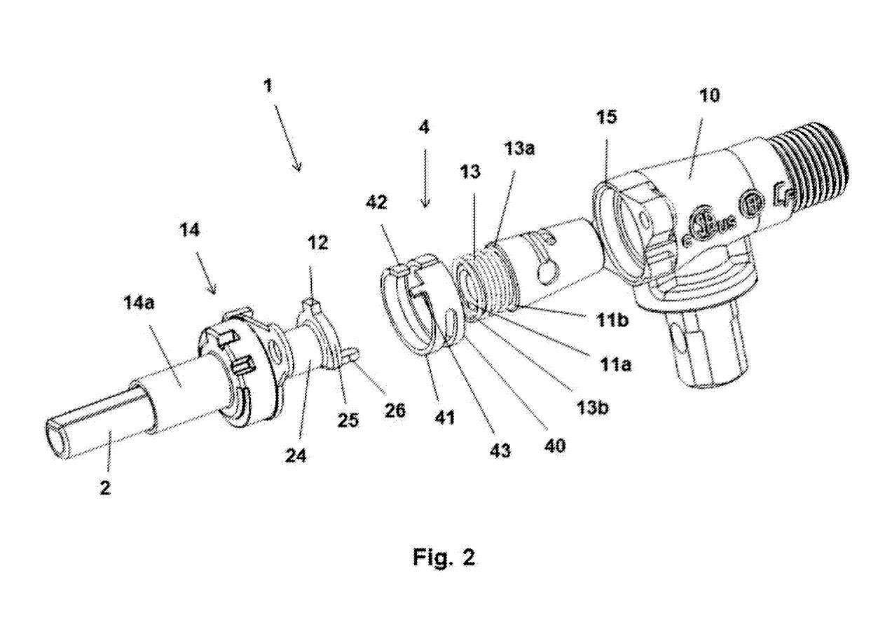

FIG. 1 shows the gas tap 1 in a longitudinal section view wherein the resistance means 4 resists against the axial pressing movement of the rotary shaft 2. FIG. 2 shows the gas tap 1 of FIG. 1 in an exploded perspective view. The pressing movement is one of the two minimum maneuvers required by the gas tap safety rules. In the state of the art, the pressing movement of the rotary shaft is the first maneuver performed by the user for opening the gas tap, and to make the maneuver more difficult and to ensure that the rotary shaft returns to its initial axial position after pressing, the gas tap typically has a return spring such as the return spring 13 shown in FIGS. 1 and 2. To make the pressing maneuver even more difficult and to prevent unintentional movements that can cause accidents, in some implementation the resistance means 4 is a spring as shown in FIGS. 1 and 2. The spring 4 may be a coil spring with one or more spirals or loops. The composition and dimensional characteristics of the spring material can vary depending on the gas tap 1 in which it is assembled, and on the desired resistance force against pressing the rotary shaft 2 to be achieved.

According to one implementation the spring 4 comprises a lower edge 40 which is located in one and the same plane, the edge 40 being supported on an edge 15 of the tap body 10. Therefore, it can be considered that the resistance means 4 is supported in a fixed portion of the tap body 10 of the gas tap 1. According to one implementation the spring 4 also comprises an upper edge 41 with a coil formation, and therefore may not entirely be located in one plane. According to one implementation the upper edge 41 has at least one section 42 that rests against the transverse means 12 of the rotary shaft 2. Hence when the user presses the shaft 2, the transverse means 12 pushes the at least one section 42 of the spring 4 supported in the tap body 10, the spring 4 resisting against the pressing movement of the rotary shaft 2.

According to one implementation the rotary shaft 2 has an end 24 directed toward the tap body 10 which comprises a rim 25. In at least one section of the edge of the rim 25 the transverse means 12 is provided, which projects outward in a direction perpendicular to the longitudinal axis of the rotary shaft 2. According to one implementation the transverse means 12 is in the form of a rectangular tab as shown in FIG. 2.

The spring 4 may also comprise a tab 43 the function of which is to fix the spring 4 to the cover 14 and thus prevent the spring 4 from rotating when a pressing and/or turning movement of the rotary shaft 2 is performed. According to one implementation the tab 43 is positioned parallel to the longitudinal axis of the rotary shaft 2 and projects from the upper edge 41 of the spring 4 towards the cover 14. The rotary shaft 2 comprises at its end 24 a tab 26 which is parallel to the longitudinal axis of the rotary shaft 2 and projects from the end 24 into an area of the edge where the rim 25 does not project, and the function of which is to drive the conical regulating member 11 for gas flow regulation when the rotary shaft 2 is turned by the user. To enable performing the driving function the conical member 11 comprises a slot 11a arranged on the side surface of a cylindrical section which projects from the conical member 11 towards the cover 14 and allows housing the return spring 13, such that this slot 11a allows housing the tab 26.

As shown in FIG. 3, the cover 14 may comprise on its internal face 14e a housing 14a for receiving the transverse means 12, the housing 14a being arranged in a position corresponding to the initial OFF position 100 of the rotation of the shaft 2. According to one implementation the housing 14a is a recess provided within the internal face 14e. As discussed above, the cover 14 also comprises a sliding surface 14b on which the transverse means 12 slides when the rotary shaft 2 is rotated. The internal face 14e also comprises a housing 14d for receiving the fixing tab 43 of the spring 4, the position of the housing 14d for the tab 43 being outside the travel of the angle of rotation A so there can be no interference whatsoever of the tab 43 with the transverse means 12 when the rotary shaft 2 is turned through the angle of rotation A.

The return spring 13 of the shaft 2 is supported at one end 13a on an edge 11b of the conical member 11, and is partially housed lengthwise in a cylindrical section projecting from the conical member 11 towards the cover 14, and resides inside the spring 4. When the spring 4 is supported on the edge 15 of the tap body 10, it is assembled concentrically with the return spring 13 arranged therein. In this arrangement the other end 13b of the return spring 13 rests on the rim 25 at the end 24 of the rotary shaft 2, the return spring 13 and the spring 4 together resisting against pressing the rotary shaft 2. When the user opens the gas tap 1, he/she first presses the rotary shaft 2 in order to operate the gas tap 1. The blocking occurs because the transverse means 12 of the rotary shaft 2 is housed in the housing 14a of the cover 14 due to the push of the return spring 13 and spring 4, and to move the transverse means 12 outside the housing 14a of the cover 14 the user has to overcome the force of the return spring 13 along with the force of the spring 4. When the pressing movement has been performed, the user may then rotate the rotary shaft 2 throughout angle A, in which movement the conical member 11 is driven with the aid of the drive tab 26 that is housed in the slot 11a of the conical member 11. In this rotational movement, at least in the section of the angle A corresponding to the OFF position to the intermediate position 102 of maximum gas flow, the rotary shaft 2 may be kept pressed so the transverse means 12 which is initially in contact with the section 42 of the spring 4 no longer has contact during the rotation since the upper edge 41 of the spring 4 does not reside in a single plane as previously discussed. Adding a new form of friction against the rotary movement of the rotary shaft 2 is thus prevented.

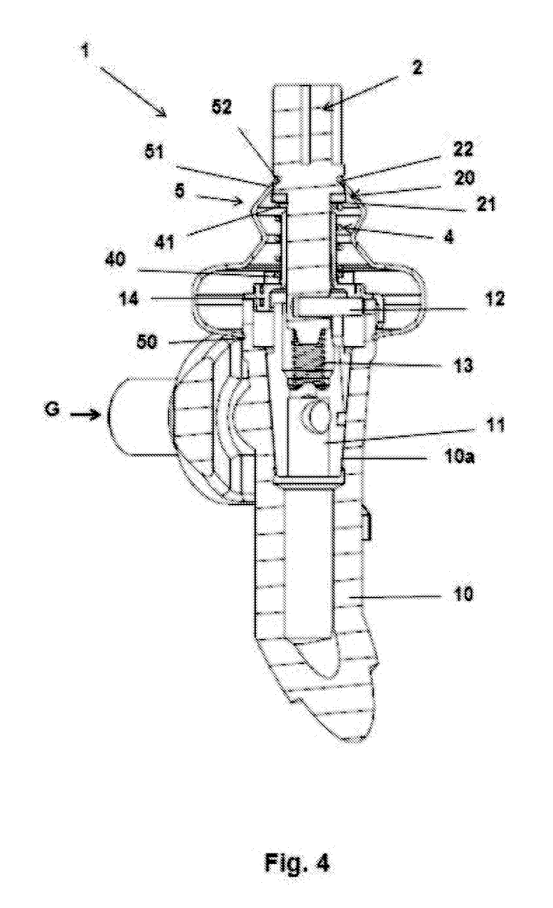

FIG. 4 shows a longitudinal section view of a gas tap 1 according to another implementation. This implementation differs from the implementation of FIG. 1 in that the resistance means 4 is arranged outside the tap body 10 instead of being arranged inside the gas tap 1. The rest of the functional and operational characteristics are substantially the same as the ones of the gas tap 1 of FIG. 1, and therefore will not be explained in detail.

The resistance means 4 of the gas tap of FIG. 4 is a coil spring working under compression. According to one implementation the coil spring 4 comprises a substantially planar lower edge 40 supported on the outer surface of the cover 14 of the gas tap 1 and a substantially planar upper edge 41 resting on a stop 20 of the rotary shaft 2. The resistance means 4 is arranged such that it is coaxial with the rotary shaft 2. According to one implementation the stop 20 of the rotary shaft 2 is a recess 21 along the periphery of the rotary shaft 2, the upper edge 41 of the resistance means 4 resting on a portion of the recess 21 which may be a surface arranged orthogonal to the longitudinal axis of the rotary shaft 2.

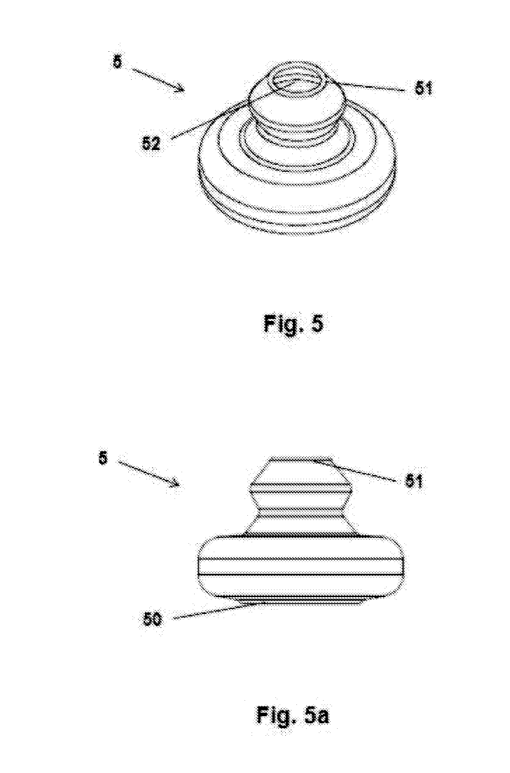

Due to the other factors that the gas tap 1 must withstand during operation when it is assembled in a gas cooking appliance such as temperature due to gas burners when they are switched on, and the combination of moisture and temperature, the resistance means 4 and the elements used for assembly thereof in the gas tap 1 need protection against the external factors which can cause the resistance means 4 to malfunction. For this purpose, according to some implementations the gas tap 1 comprises a protective element 5 covering the resistance means 4 on the outside. According to one implementation the protective element 5 is made of a flexible material, such as silicone, that is capable of withstanding a temperature of at least 150° C. FIG. 5 shows a perspective view of the protective element 5 of the gas tap 1 of FIG. 4. FIG. 5a shows a front view of the protective element 5 of the gas tap 1 of FIG. 4. According to one implementation the protective element 5 comprises a base 50 which is supported on the tap body 10, and an upper end 51 with a hole 52 allowing the passage of the rotary shaft 2. The upper end 51 is housed in a slot 22 comprised in the rotary shaft 2, the slot 22 being orthogonal to the longitudinal axis of the rotary shaft 2, the slot 22 being arranged in the rotary shaft 2 in a position further away from the cover 14 than the recess 21 of the rotary shaft 2. The upper edge 41 of the resistance means 4 rests on the lower portion of the recess 21, such that when the rotary shaft 2 is pressed, the recess 21 pushes the resistance means 4 against the cover 14 and the slot 22 drives the protective element 5 to cause it to at least partially collapse. In the initial OFF position of the rotary shaft 2, the user needs to overcome the force of the resistance means 4 in addition to the force of the return spring 13 to perform a rotational movement of the shaft 2. During such operation the resistance means 4 is protected from external factors with the protective element 5.

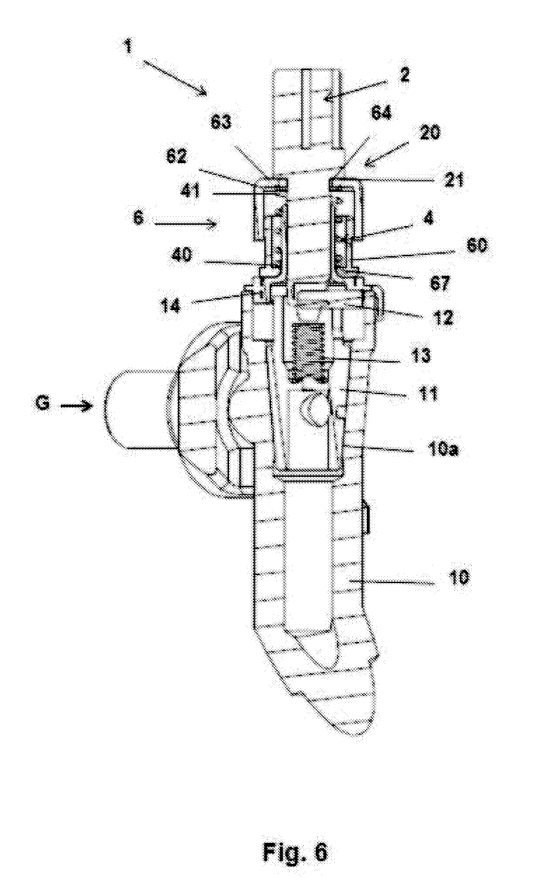

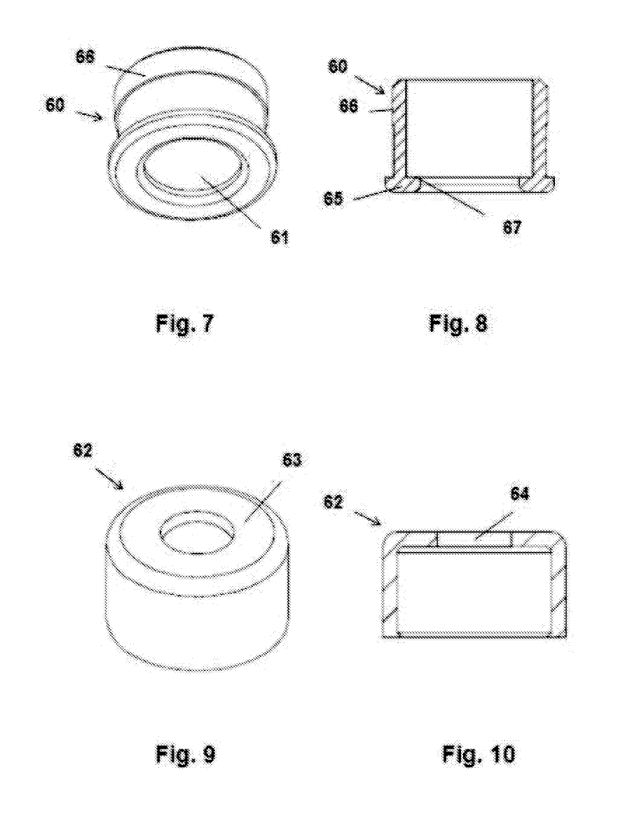

FIG. 6 shows a longitudinal section of a gas tap 1 according to another implementation. As shown in FIG. 6, the resistance means 4 is arranged outside the tap body 10 with a protective assembly 6 covering the resistance means 4 from the outside. According to one implementation the protective assembly 6 comprises a substantially cylindrical hollow fixed body 60 having a circular base 65 which is supported on the cover 14 of the gas tap 1, the fixed body 60 having a hole 61 allowing the passage of the rotary shaft 2. The base 65 forms a flange 67 inside the fixed body 60. The protective assembly 6 also comprises a substantially cylindrical hollow movable body 62, which is assembled on the fixed body 60 and slides on the outside of the fixed body 60 when assembled, the movable body 62 comprising an upper surface 63 with a hole 64 allowing the passage of the rotary shaft 2. FIG. 7 shows a perspective view of the fixed body 60 of the protective assembly 6 of the gas tap 1 of FIG. 6, and FIG. 8 shows a longitudinal section view of the fixed body 60 shown in FIG. 7. FIG. 9 shows a perspective view of the movable body 62 of the protective assembly 6 of the gas tap 1 of FIG. 6, and FIG. 10 shows a longitudinal section view of the movable body 62 shown in FIG. 9. The resistance means 4 is housed inside the protective assembly 6, the upper edge 41 of the resistance means 4 resting on the internal face of the upper surface 63 of the movable body 62 and being coaxial with the hole 64. Once the protective assembly 6 is assembled with the resistance means 4 therein, the outer face of the upper surface 63 rests on the lower portion of the recess 21 of the rotary shaft 2.

An upper portion of the outer side surface of the fixed body 60 comprises a section 66 having an outer diameter that is greater than the outer diameter of the remaining portion of the outer side surface of the fixed body 60. The movable body 62 comprises an internal side surface with an internal diameter that fits the outer diameter of the section 66 of the fixed body 60. According to one implementation the resistance means 4 is a coil spring working under compression comprising a substantially planar lower edge 40 which is supported on the flange 67 of the fixed body 60.

Upon the rotary shaft 2 being pressed, a surface formed by the recess 21 pushes the upper surface 63 of the movable body 62 with the upper surface 63 in turn pushing the resistance means 4 against the cover 14. The movable body 62 shifts on the fixed body 60 as the user applies an axial force to the rotary shaft 2 to overcome the force of the resistance means 4 and the return spring 13. This is accomplished with the resistance means 4 protected from external factors by the protective assembly 6.

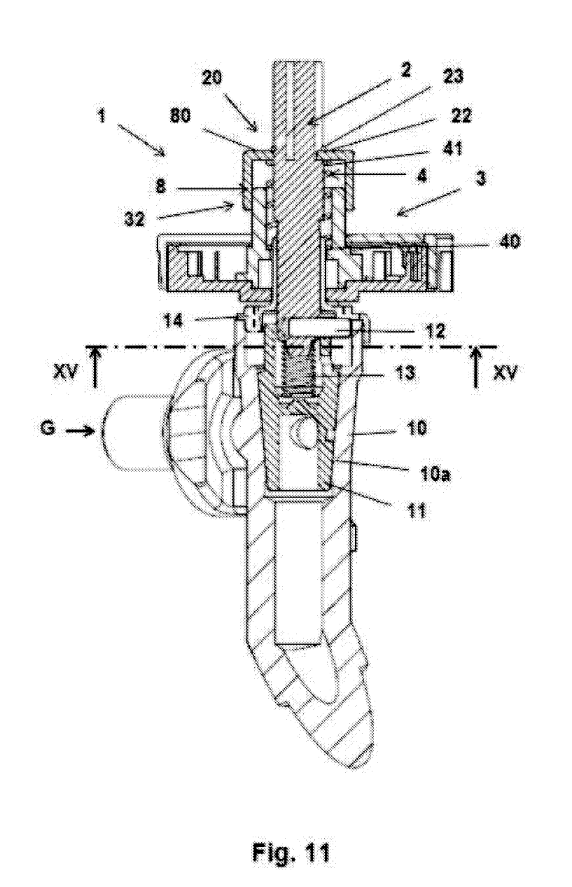

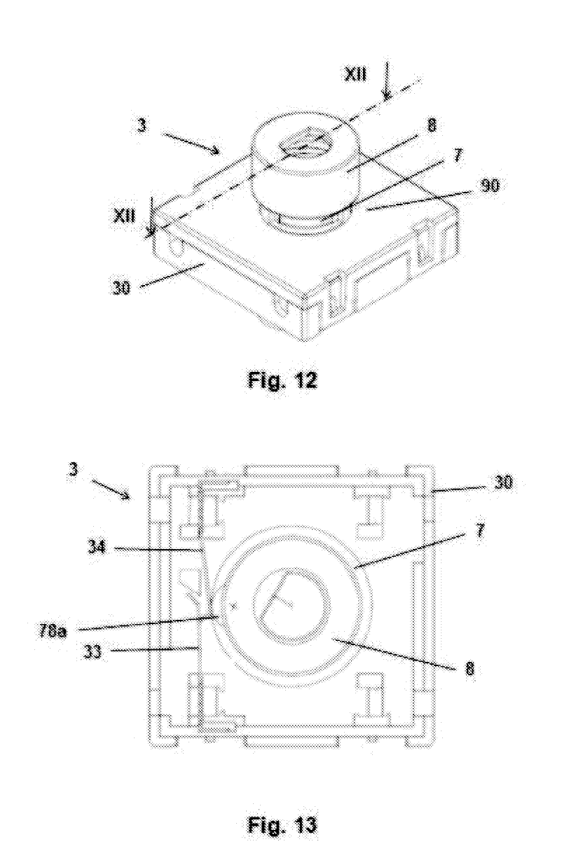

FIG. 11 shows a longitudinal section view of a gas tap 1 according to another implementation with the resistance means 4 arranged outside the tap body 10. The gas tap 1 comprises an ignition switch assembly 3 coupled to the rotary shaft 2, the resistance means 4 being arranged at least partially in the ignition switch assembly 3. FIG. 12 shows a top perspective view of the ignition switch assembly 3 while FIG. 13 shows a plan view of the ignition switch assembly 3 of FIG. 12 without the front cover 90. According to one implementation the ignition switch assembly 3 is in the form of a box and comprises a casing 30 suitable for being fixed to the gas tap 1. According to one implementation the casing 30 comprises means (not shown in the figures) for facilitating its attachment with the cover 14 by means of attachment elements. The ignition switch assembly 3 also includes a fixed contact means 33 and a movable contact means 34 housed in the casing 30, the movable contact means 34 being movable relative to the fixed contact means 30 and upon making contact with the fixed contact means 30 forms an electrical circuit for delivering power to a spark generator (not shown in the figures) used to ignite a gas residing in a burner of the gas appliance. The gas tap 1 includes protective assembly 32 that turns and is integral with the rotary shaft 2 in the rotational movement of the shaft, the resistance means 4 being housed inside the protective assembly 32 and being coaxial with the rotary shaft 2.

The protective assembly 32 comprises a cam assembly 7 which is coupled to the casing 30 and to the front cover 90, the cam assembly 7 being housed partially inside the switch 3, and projecting partially outside the casing 30 from the front cover 90. The cam assembly 7 turns in the casing 30 and the front cover 90 when the rotary shaft 2 performs a rotational movement. The ignition switch assembly 3 also comprises a drive cover 8 coupled to the cam assembly 7, which is coupled with the rotary shaft 2, the drive cover 8 turning when the rotary shaft 2 performs a rotational movement.

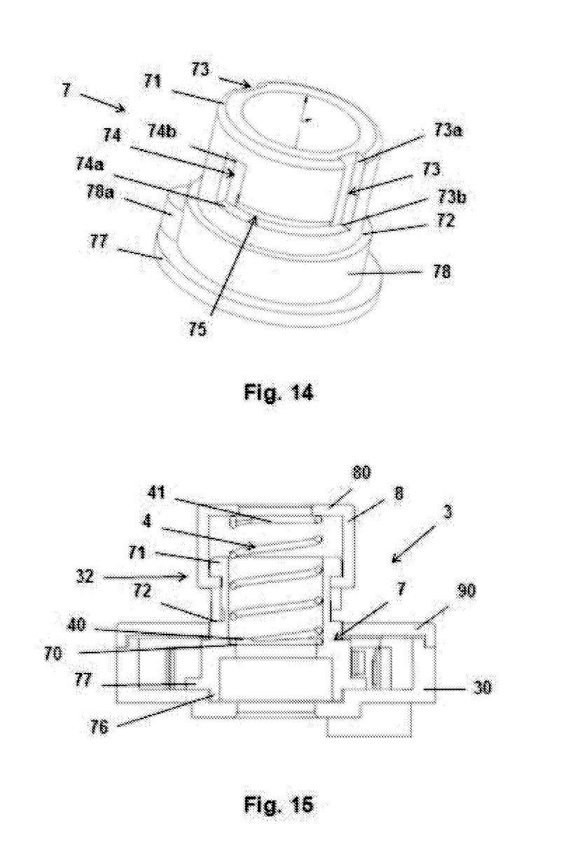

FIG. 14 shows a perspective view of the cam assembly 7 of the ignition switch assembly 3 of FIG. 12. FIG. 15 shows a front section view of the ignition switch assembly 3 according to line XII-XII of FIG. 12. The cam assembly 7 may be a substantially cylindrical body having different diameters externally and internally with various functions that will be explained below. The cam assembly 7 is internally hollow with respect to its longitudinal axis to allow the passage of the rotary shaft 2. The cam assembly 7 comprises a lower end 76 and an upper end 71, an internal side surface with a flange 70, and an outer side surface with a rim 77 close to the lower end 76, projecting orthogonally with respect to the longitudinal axis of the cam assembly 7, forming an angle bracket between the rim 77 and the lower end 76. On the outer side surface is a flange 72. A cam 78a is arranged on an outer surface 78 that is located between the rim 77 and the flange 72. The cam 78a projects from the outer surface 78 in an angular section of the circumference of the surface 78 and has a shape that causes it to engage with and shift the movable contact means 34 into contact with the fixed contact means 33 when the cam assembly 7 is rotated between a selective angular range.

FIG. 15a shows a perspective section view of the ignition switch assembly 3 according to line XII-XII of FIG. 12. As shown, the casing 30 comprises a base 35 at a bottom in which there is a circular housing 36 substantially centered in the base 35, forming a height recess with respect to the base 35, the housing 36 comprising a hole 37 in its center. The front cover 90 of the ignition switch assembly 3 comprises a hole 91 substantially centered with the hole 37 of the casing 30, the holes 37 and 91 allowing the passage of the rotary shaft 2. The rim 77 and the lower end 76 of the cam assembly 7 are fitted such that they rest on the edge formed between the base 35 and the housing 36 of the casing 30, such that the rim 77 can slide on the base 35, whereas the lower end 76 of the cam assembly 7 rests on the edge formed between the base 35 and the housing 36 of the casing 30. Once the fitting is performed, the front cover 90 fits with the cam assembly 7 through hole 91, the edge of the hole 91 resting on the flange 72 of the cam assembly 7.

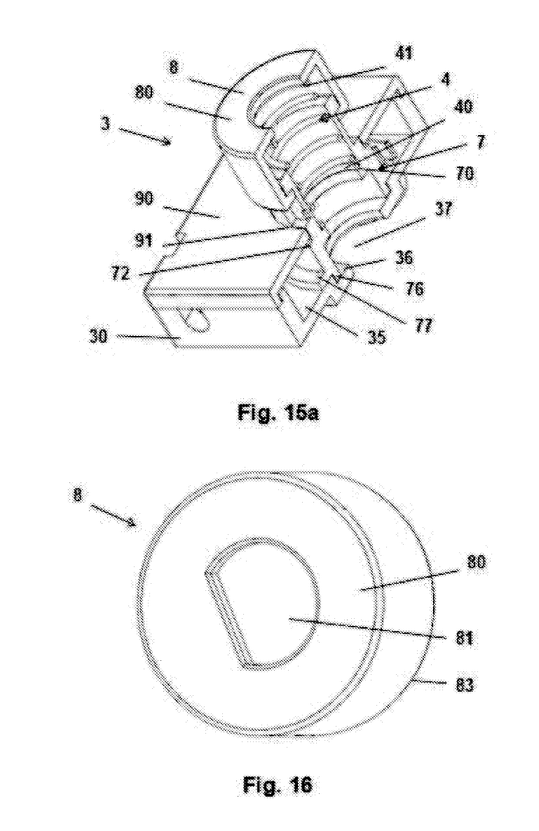

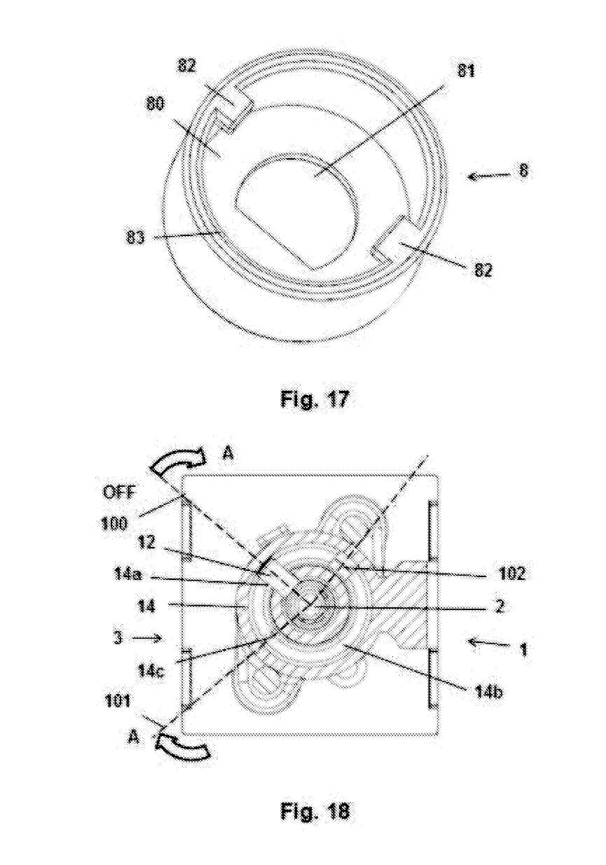

FIG. 16 shows a front perspective view of the drive cover 8 of the ignition switch assembly 3 of FIG. 12. FIG. 17 shows a rear perspective view of the drive cover 8. The drive cover 8 is a substantially cylindrical hollow body, being hollow in its longitudinal axis allowing the passage of the rotary shaft 2 there through. The drive cover 8 is partially closed in its upper portion by an upper surface 80, the upper surface 80 comprising a substantially centered hole 81. According to one implementation the hole 81 is D-shaped which allows coupling to the rotary shaft 2 having the same shape in that zone of the shaft, which allows making the drive cover 8 integral with the rotary shaft 2 when the rotary shaft 2 turns in a rotational movement. According to one implementation the drive cover 8 comprises two ribs 82 arranged on the circular edge of the lower end 83 of the drive cover 8, the ribs 82 projecting orthogonally with respect to the longitudinal axis of the drive cover 8 towards the inside thereof. The height of the ribs 82 in the direction of the longitudinal axis of the drive cover 8 can be variable, and the width in the direction of the circumference of the lower end 83 of the drive cover 8 is different in each of the two ribs 82. According to one implementation both ribs 82 in the circular edge of the lower end 83 are arranged at about 180° with respect to one another.

In FIG. 14 the cam assembly 7 is shown in a perspective view, According to one implementation the cam assembly 7 comprises on its outer side surface, and above the flange 72 two open channels 73 and two closed channels 74 that are substantially vertical in the direction of the longitudinal axis of the cam assembly 7. The cam assembly 7 also comprises two connection channels 75 that are substantially horizontal, and therefore circling a portion of the outside of the side surface, each connecting an open channel 73 with a closed channel 74. Each of the open channels 73 comprises an open end 73a arranged at the upper end 71 of the cam assembly 7, and a lower end 73b connected with the corresponding connection channel 75. Each of the closed channels 74 comprises a lower end 74a connecting with the corresponding connection channel 75, and an upper closed end 74b closed by the side surface of the cam assembly 7. According to one implementation the open channels 73 are arranged at about 180° with respect to one another, and the closed channels 74 are also arranged at about 180° with respect to one another. This arrangement of the different channels of the cam assembly 7 connected to one another allows a coupling of the drive cover 8 with the cam assembly 7. To perform the coupling, the widths of the two open channels 73, in the direction of the circumference of the upper end 71 of the cam assembly 7, are different from one another, similarly the widths of the two closed channels 74, in the direction of the circumference of the side surface of the cam assembly 7, are also different from one another, but the same as the respective widths of the open channels 73, each of the different widths coinciding with the different widths of the two ribs 82, respectively. The drive cover 8 is thus coupled to the cam assembly 7 by fitting the ribs 82 coinciding in width in each open channel 73, the drive cover 8 thus being assembled in the cam assembly 7 with a poka-yoke formed, two by two, with the different widths of the ribs 82 and the open channels 73 and closed channels 74. The drive cover 8 is then shifted vertically downwards along the open channels 73 to the lower end 73b thereof, and connecting with each connection channel 75. The drive cover 8 is then turned counter-clockwise an angle of about 90°, shifting the ribs 82 along the connection channels 75 to the lower end 74b of the closed channels 74.

FIGS. 15 and 15a show the resistance means 4 as assembled in the ignition switch assembly 3. FIG. 11 shows gas tap 1 fully assembled. According to one implementation the resistance means 4 is a compression spring with a substantially planar lower edge 40 supported on the flange 72 of the cam assembly 7, and a substantially planar upper edge 41 resting on the internal face of the upper surface 80 of the drive cover 8 when the drive cover 8 is coupled to the cam assembly 7, the resistance means 4 being coaxial with the rotary shaft 2. When coupling the drive cover 8 to the cam assembly 7, and after placing the ribs 82 of the drive cover 8 at the lower end 74b of the closed channels 74, the force exerted by the resistance means 4 on the internal face of the upper surface 80 of the drive cover 8 shifts the ribs 82 and therefore the drive cover 8 vertically upwards along the closed channels 74 until they abut the upper end 74b of the closed channels 74. The drive cover 8 is thus assembled in the cam assembly 7 and therefore in the ignition switch assembly 3.

FIG. 11 shows the rotary shaft 2 as part of the gas tap 1 and in which the ignition switch assembly 3 is coupled. The rotary shaft 2 comprises a stop 20 orthogonal to the longitudinal axis of the rotary shaft 2. According to one implementation the stop 20 being a washer 23 housed in a slot 22 orthogonal to the longitudinal axis of the rotary shaft 2, the slot 22 being arranged in a position along the length of the rotary shaft 2 such that the washer 23 abuts the outer face of the upper surface 80 of the drive cover 8. When the user manually operates the rotary shaft 2 to maneuver the gas tap 1, the first operation that he/she performs is to press the rotary shaft 2. With the described arrangement of the washer 23, upon pressing the rotary shaft 2, it drives the washer 23 in the shifting movement, and since the washer 23 rests on the upper surface 80 of the drive cover 8, the drive cover 8 is shifted. The shifting is allowed by the ribs 82 housed in the closed channels 74 of the cam assembly 7 at its upper end 74b, the ribs 82 being shifted along the closed channels 74 but without coming out of the same. The resistance means 4 resists against the shifting of the ribs 82 of the drive cover 8, which is coupled in the resistance to the shifting with the resistance force exerted by the return spring 13 against the pressing movement of the rotary shaft 2. The spring forming the resistance means 4 has a defined force preventing the ribs 82 of the drive cover 8 from reaching the lower end 74a of the closed channels 74, the rotary shaft 2 furthermore having a mechanical stop resting on the cover 14 and preventing it from exceeding the length of travel of the closed channels 74.

FIG. 18 shows a cross-section view of the gas tap 1 according to line XV-XV of FIG. 11. FIG. 18 shows the internal face of the cover 14 of the gas tap 1. In the internal face the cover 14 comprises a housing 14a for receiving the transverse means 12 of the rotary shaft 2 and blocking the rotation of the rotary shaft 2. The internal face further comprises a sliding surface 14b for the transverse means 12 and a stop 14c. The rotary shaft 2 can turn an angle of rotation A in any of the two directions from an initial position 100 located at 0° corresponding to the closed OFF position of the gas flow to a final position 101 corresponding to a minimum gas flow which according to on implementation is located at 270°, and passes through an intermediate position 102 corresponding to a maximum gas flow located according to one implementation at 90°. When the gas tap 1 is closed, the transverse means 12 is arranged in the housing 14a in the initial OFF position 100 blocking the rotation of the rotary shaft 2, and when the gas tap 1 is to be opened the rotary shaft 2 is pressed, overcomes the resistance force of the return spring 13 and of the resistance means 4, the transverse means 12 being released from its housing 14a. When the rotary shaft 2 is turned, the transverse means slides along the sliding surface 14b, passing through the intermediate position 102, and can reach the stop 14c indicating the final position 101 of minimum gas flow.

According to one implementation, upon the rotary shaft 2 being rotated to an angle of about 40° the gas tap 1 opens to permit a gas flow there through. In the rotational movement the cam 78a starts to contact with the movable contact means 34 of the cam assembly 7 at a rotational angle of about 20° and the contact is maintained up to an angle of about 115°. In the contact movement, the movable contact means 34 is shifted until contacting with the fixed contact means 33, electrical contact being produced in that contact in at least one turning direction from the initial position 100, and sparks thereby being produced by means of the spark generator (not shown in the drawings), finally causing the ignition of the flame. A sufficiently large section of the angle of rotation A of 20° to 115° is thus obtained so that a flame can be generated from the position of 40° in which there is already gas flow, and the user can stop pressing the rotary shaft 2 in the position 102 of maximum gas flow due to the initiation of the opening of the gas tap 1, and can then regulate the position of the shaft 2 where needed.

As discussed above, the rotary shaft is moveable between a first axial position where its rotation is prevented and a second axial position whereupon its rotation is permitted for regulating the flow of gas through the gas tap. According to some implementations the resistance force provided by the return spring 13 on the rotary shaft when the rotary shaft assumes the second axial position is 2 to 8 Newtons, and more preferably 3 to 6 Newtons. According to some implementations the resistance force provided by the resistance element 4 on the rotary shaft when the rotary shaft assumes the second axial position is between 5 to 20 Newtons, and more preferably between 10 to 16 Newtons. According to some implementations the combined resistance force provided by the return spring 13 and resistance element 4 on the rotary shaft when the rotary shaft assumes the second axial position is between 7 to 28 Newtons, and more preferably between 13 to 22 Newtons.

What is claimed is:

1. A gas tap for a cooking appliance comprising:
a tap body with an internal housing,
a rotational gas flow regulating member located in the internal housing for regulating the flow of a gas through the gas tap,
a manually-operated rotary shaft having a first end and a second end opposite the first end, the rotary shaft coupled to the gas flow regulating member at or near its second end, the flow regulating member being rotatable with the rotary shaft, the rotary shaft being moveable between a first axial position where its rotation is prevented and a second axial position whereupon its rotation is permitted,
a return spring located in the internal housing of the gas tap, the return spring arranged to directly or indirectly act upon the rotary shaft to resist against an axial movement of the rotary shaft from the first axial position to the second axial position; and
a resistance element other than the return spring that is also arranged to directly or indirectly act upon the rotary shaft to resist against an axial movement of the rotary shaft from the first axial position to the second.

2. A gas tap according to claim 1, further comprising:
a transverse member situated at or near the second end of the rotary shaft, the transverse member axially and rotationally movable with the rotary shaft; and
a cover covering the internal housing of the tap body with at least a portion of the rotary shaft passing through the cover, the cover having an internal face containing a recess for receiving at least a portion of the transverse member when the rotary shaft is in an OFF position corresponding to a zero gas flow through the gas tap, the rotary shaft being in the first axial position and being prevented from rotating when the at least portion of the transverse member is situated in the recess, when the rotary shaft is in the second axial position the transverse member is situated outside the recess and the rotary shaft is permitted to rotate.

3. A gas tap according to claim 1, wherein the resistance against the axial movement of the rotary shaft provided by the resistance element is greater than the resistance against the axial movement of the rotary shaft provided by the return spring.

4. A gas tap according to claim 2, wherein the resistance element is a coil spring with at least two spirals, the coil spring comprising a lower edge which is supported on a surface of the tap body and an upper edge resting on a section of the transverse member.

5. A gas tap according to claim 4, wherein the transverse member is arranged substantially perpendicular to the longitudinal axis of the rotary shaft.

6. A gas tap according to claim 4, wherein the resistance element comprises a first part that cooperates with a portion of the cover to limit rotational movement of the resistance element when the rotary shaft is rotated.

7. A gas tap according to claim 6, wherein the internal face of the cover has a sliding surface on which the transverse member slides when rotated in a selective angular range, the portion of the cover that cooperates with the first part residing at a location on the cover outside the selective angular range.

8. A gas tap according to claim 6, wherein the rotary shaft comprises a longitudinal axis, the first part being a fixing tab extending parallel to the longitudinal axis of the rotary shaft and projecting from the upper edge of the resistance element.

9. A gas tap according to claim 6, further comprising a second part that rotates with the rotary shaft, the gas flow regulating member having a housing that receives the second part, the gas flow regulating member being rotatable with the rotary shaft by an engagement of the second part with the housing in the gas flow regulating member.

10. A gas tap according to claim 9, wherein the rotary shaft comprises a longitudinal axis, the second part comprising a drive tab that projects from the second end of the rotary shaft and is parallel to the longitudinal axis of the rotary shaft, the housing in the gas flow regulating member comprising a slot, the slot being parallel to the longitudinal axis of the rotary shaft.

11. A gas tap according to claim 1, wherein each of the resistance element and the return spring is a coil spring, the return spring being arranged concentrically inside the resistance element.

12. A gas tap according to claim 11, wherein the resistance element comprises at least two spirals and has a lower edge which is supported on a surface of the tap body and an upper edge resting on a section of the transverse member, the return spring resting at one end on an edge of the gas flow regulating member and resting at another end on a rim of the second end of the rotary shaft.

13. A gas tap according to claim 1, wherein the resistance element is arranged outside the tap body.

14. A gas tap according to claim 13, wherein the resistance element is a coil spring working under compression, the coil spring having a lower edge cooperating with at least a portion of the cover and an upper edge cooperating with a stop on the rotary shaft, the resistance element being substantially coaxial with the rotary shaft.

15. A gas tap according to claim 14, wherein the rotary shaft comprises a longitudinal axis, the stop comprising a surface on the rotary shaft that is substantially orthogonal to the longitudinal axis of the rotary shaft, the upper edge of the resistance element cooperating with the orthogonal surface of the rotary shaft, the lower edge of the resistance element being supported on the cover.

16. A gas tap according to claim 13, further comprising a protective element made of a flexible material covering the resistance element.

17. A gas tap according to claim 13, wherein the rotary shaft comprises a longitudinal axis, the gas tap further comprising a protective element made of a flexible material covering the resistance element, the resistance element being a coil spring working under compression, the coil spring having a lower edge cooperating with at least a portion of the cover and an upper edge cooperating with a stop on the rotary shaft, the resistance element being substantially coaxial with the rotary shaft, the stop comprising a surface on the rotary shaft that is substantially orthogonal to the longitudinal axis of the rotary shaft, the upper edge of the resistance element cooperating with the orthogonal surface of the rotary shaft, the lower edge of the resistance element being supported on the cover.

18. A gas tap according to claim 17, wherein the protective element comprises a base which is supported on the tap body, and an upper end with a hole allowing the passage of the rotary shaft, the upper end being housed in a slot arranged orthogonal to the longitudinal axis of the rotary shaft, the slot being arranged in a position nearer the first end of the rotary shaft than the orthogonal surface of the rotary shaft that cooperates with the upper edge of the resistance element, the protective element susceptible to collapse upon the rotary shaft being pressed upon and urged inward of the internal housing of the tap body.

19. A gas tap according to claim 13, wherein the rotary shaft comprises a longitudinal axis, the gas tap further comprising a protective assembly covering the resistance element, the resistance element being a coil spring having a lower edge and an upper edge, the coil spring being substantially coaxial with the rotary shaft, the protective assembly comprising a hollow fixed body with a base supported on the cover, the fixed body comprising a hole allowing the passage of the rotary shaft, the base comprising an internal flange, the protective assembly further comprising a hollow movable body that slides on an external surface of the fixed body, the movable body having an upper surface with a hole allowing the passage of the rotary shaft, the resistance element being housed inside the protective assembly, the upper edge of the resistance element resting on an internal face of the upper surface of the movable body, an outer face of the upper surface of the movable body resting on a surface of the rotary shaft that is orthogonal to the longitudinal axis of the rotary shaft, the lower edge of the resistance element being supported on the internal flange of the fixed body

20. A gas tap according to claim 14, further comprising an ignition switch assembly coupled to the rotary shaft, the resistance element being at least partially disposed in or on the ignition switch assembly, the ignition switch assembly comprising a casing fixed to the gas tap, a fixed contact element and a movable contact element housed in the casing, the fixed and movable contact elements being spaced apart with the movable contact element being movable into contact with the fixed contact element, when in contact the fixed and moveable contacts complete a circuit for delivering power to a spark generator, the gas tap further comprising a protective assembly that turns with the rotary shaft, the resistance element being at least partially housed inside the protective assembly, the protective assembly comprising a cam assembly that is coupled to the casing, a cam element projecting from the cam assembly is configured to act upon the moveable contact element to move it into contact with the fixed contact element during a selective range of angular positions of the rotary shaft.

21. A gas tap according to claim 1, wherein a resistance force provided by the return spring on the rotary shaft when the rotary shaft assumes the second axial position is between about 2 to 8 Newtons, the resistance force provided by the resistance element on the rotary shaft when the rotary shaft assumes the second axial position being between about 5 to 20 Newtons.

22. A gas tap according to claim 1, wherein a resistance force provided by the return spring on the rotary shaft when the rotary shaft assumes the second axial position is between about 3 to 6 Newtons, the resistance force provided by the resistance element on the rotary shaft when the rotary shaft assumes the second axial position being between about 10 to 16 Newtons.

23. A gas tap according to claim 1, wherein the combined resistance force provided by the return spring and resistance element on the rotary shaft when the rotary shaft assumes the second axial position is between about 7 to 28 Newtons.

24. A gas tap according to claim 1, wherein the combined resistance force provided by the return spring and resistance element on the rotary shaft when the rotary shaft assumes the second axial position is between about 13 to 22 Newtons.
